(19) United States
(12) Patent Application Publication
(10) Pub. No.: US 2016/0001381 A1
(43) Pub. Date: Jan. 7, 2016

(54) Cutting tool, especially a friction tool, milling tool or drilling tool.

(71) Applicant: Jakob Lach GmbH & Co. KG, Hanau (DE)

(72) Inventor: Horst LACH, Hanbau (DE)

(21) Appl. No.: 14/791,424

(22) Filed: Jul. 4, 2015

(30) Foreign Application Priority Data
Jul. 4, 2014 (DE) 102014109390.9

(51) Int. Cl. B23B 51/04; B23C 5/10

(52) U.S. Cl. CPC B23B 51/0493; B23C 5/109; B23B 2250/12; B23B 2251/50; B23B 2226/125; B23B 2226/315; B23C 2226/125; B23C 2226/315; B23C 2250/12

(57) ABSTRACT

The invention relates to a cutting tool (10, 40, 54), especially a friction tool, milling tool or drilling tool, with at least one cutting insert (14, 42, 56) fastened on a tool body (12) and comprising at least one free surface or at least one round, beveled surface and preferably comprising at least one free surface, preferably consisting of polycrystalline diamond (PCD) or cubic boron nitride (CBN). In order to improve the cooling, the removal of chips and the lubrication of the at least one cutting insert, it is provided that a coolant conduit (30) run through the tool body (12) forms a connection to at least one coolant conduit section (32, 34, 72) worked into the cutting insert (14, 42, 56) and with at least one mouth opening (36, 70, 76) in the round, beveled surface (60) and/or free surface (24, 44, 62) of the cutting insert (14, 42, 56).

The invention relates to a cutting tool, especially a friction tool, milling tool or drilling tool, with at least one cutting insert fastened on a tool body and comprising at least one free surface or at least one round, beveled surface and preferably comprising at least one free surface, preferably consisting of polycrystalline diamond (PCD) or cubic boron nitride (CBN), wherein a coolant conduit run through the tool body forms a connection to a coolant conduit section worked into the cutting insert and with at least one mouth opening in the cutting insert.

Such a cutting tool is described in DE 10 2009 030 587 B3. In the known cutting tool the coolant conduit section is formed only partially in the cutting insert and on the remaining part of the circumference in the base body of the tool. A groove open on the circumference is worked into the cutting insert with a wire electrode or a laser in such a manner that the coolant conduit section empties in a face of the cutting insert.

JP 2010-094 747 A relates to a cutting tool and a cutting insert for such a tool. The cutting tool comprises a tool body that rotates about an axis and with a front-side front surface on which cutting inserts are arranged. The cutting inserts have a cutting edge on their outer circumference. Furthermore, the cutting insert has a face that faces in the direction of rotation and has a free surface that cuts the face. A cutting line between the face and the free surface forms a main cutting edge. Furthermore, a supply opening penetrating the cutting insert is provided that is connected to a supply conduit formed in the tool body in order to supply the free surface with cutting liquid.

JP 05 301 104 A relates to a disposable tool tip and a method for producing such a tip. Perforations are provided in the tool tip for supplying a cooling liquid, wherein each of the perforations has its own opening on the free surface of the disposable cutting insert.

U.S. Pat. No. 4,535,216 A describes a metalworking tool with electrical heating. The metalworking tool comprises a cutting insert with chip breakers. Conduits for a cooling fluid are provided in the cutting insert, wherein the conduits empty in a free surface of the cutting insert.

Starting from the above, the present invention has the basic problem of further developing a cutting tool of the initially cited type in such a manner that the cooling, chip removal and lubrication of the at least one cutting insert are improved.

The problem is solved in accordance with the invention, among other things, by the features of claim 1. It is provided that the at least one cooling conduits section empties with at least one mouth opening in the round bevel surface and/or in the free surface of the cutting insert.

A preferred embodiment relates to a cutting tool, especially a friction tool, milling tool or drilling tool, with at least one cutting insert fastened on a tool body and comprising at least one free surface and preferably consisting of polycrystalline diamond (PCD) or cubic boron nitride (CBN), wherein a coolant conduit run through the tool body forms a connection to at least one coolant conduit section worked into the cutting insert and with at least one mouth opening in the free section of the cutting insert.

The problem is furthermore solved by a cutting tool, especially a friction tool, milling tool or drilling tool, with at least one cutting insert fastened on a tool body and comprising at least one round beveled surface and preferably at least one free surface, preferably consisting of polycrystalline diamond (PCD) or cubic boron nitride (CBN), wherein a coolant conduit run through the tool body forms a connection to at least one coolant conduit section worked into the cutting insert and with at least one mouth opening in the round beveled surface and that preferably forms at least one free section of the cutting insert.

The embodiments of the invention, namely, that the coolant conduit section empty on the circumference side in the round beveled surface and/or free surface of the cutting insert achieve the advantage that as a supplement to the cooling of the cutting insert on the tool surface to be worked a coolant film such as an oil film is produced that makes an improved service life possible at high work speeds. In particular, a blocking of the tool in the workpiece is minimized In addition to the cooling effect and to the formation of a coolant film on the workpiece surface to be worked between bordering cutting inserts an improved chip removal is also achieved, especially by the coolant exiting from the mouth openings in the free surface.

It is provided for improving the cooling action that the coolant conduit sections run completely in the cutting insert. The coolant conduit section running through the cutting insert is preferably constructed as a borehole. The borehole can be formed by electroeroding or laser methods.

In order to achieve the most effective and planar distribution possible for forming the coolant film, it is provided that the coolant section on the round, beveled surface empties in a funnel-shaped mouth opening. The funnel-shaped mouth opening makes possible a connection off coolant and therefore a better distribution on the workpiece surface to be worked. In addition, the formation of a backup pressure is avoided. Therefore, as a result of the forming oil film the friction between the round beveled surface and the workpiece surface is reduced with the consequence that a blocking of the tool in the workpiece is minimized

The cutting insert is preferably constructed as a solid PCD or solid CBN and has a width BS in the range of 1.5 mm≦BS≦5 mm, preferably BS=2.5 mm.

Another preferred embodiment is characterized in that the cutting insert is constructed as a sandwich PCD or sandwich CBN comprising a hard metal carrier with a width BH in the range of 1 mm≦BH≦2 mm, preferably BH=1.5 mm, and a PCD- or CBN diamond layer with a width BD in the range of 0.5 mm≦BD≦1.5 mm, preferably BD=1 mm.

The coolant conduit section preferably has a diameter of DK in the range of 0.15 mm≦DK≦1.5 mm, preferably DK=0.6 to 0.8 mm

The funnel-shaped mouth opening in the round beveled surface can have a diameter DM in the range of 0.5 mm≦DM≦1.5 mm, preferably DM 1.0 mm. The funnel-shaped mouth opening can be constructed to be round or elliptical.

The cutting tool can be designed as a drilling tool, milling tool or friction tool.

In order to obtain the best possible uniform distribution of the coolant for forming an oil film and for cooling the cutting insert in its longitudinal extension, it is provided that the cutting insert comprises several mouth openings for coolant along its longitudinal extension of the round beveled surface and/or free surface. The coolant conduit sections connected to the mouth openings preferably have a radial course. Alternatively, the coolant conduit sections can be aligned at an angle to the longitudinal axis of the tool body for generating a preferred exit direction.

Other details, advantages and features of the invention result not only from the claims, the features to be gathered from them by themselves and/or in combination, but also from the following description of a preferred exemplary embodiment to be gathered from the drawings.

### IN THE DRAWINGS

FIG. 1 shows a perspective view of a first embodiment of a milling tool with two cutting inserts of solid PCD,

FIG. 2 shows a side view of the milling tool according to FIG. 1,

FIG. 3 shows a front view of the milling tool according to FIG. 1 and FIG. 2,

FIG. 4 shows a cross section along section line A-A according to FIG. 2,

FIG. 5 shows a perspective view of a second embodiment of a milling tool with two cutting inserts of sandwich PCD,

FIG. 6 shows a side view of the milling tool according to FIG. 5,

FIG. 7 shows a front view of the milling tool according to FIG. 5 and FIG. 6,

FIG. 8 shows a cross section along section line A-A according to FIG. 6,

FIG. 9 shows a perspective view of a front end of a third embodiment of a cutting tool in the form of a friction tool with two cutting inserts of solid PCD,

FIG. 10 shows a side view of the front end of the friction cool according to FIG. 9,

FIG. 11 shows a cross section along section line H-H according to FIG. 10,

FIG. 12 shows a perspective view of the friction tool in a borehole of a workpiece,

FIG. 13 shows a side view of the friction tool in the workpiece,

FIG. 14 shows a sectional view of the friction tool in the workpiece, along the line J-J according to FIG. 13,

FIG. 15 shows an enlarged view of a detail K according to FIG. 14.

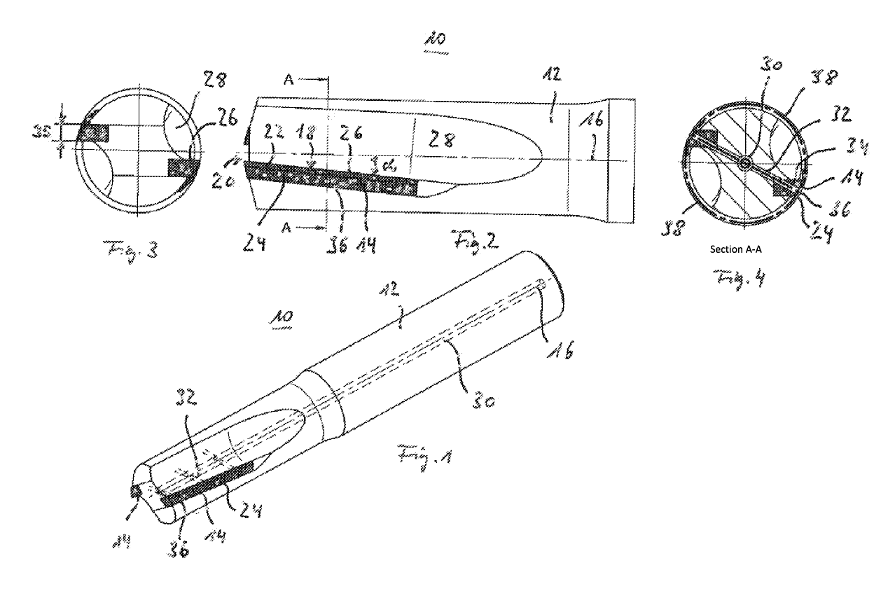

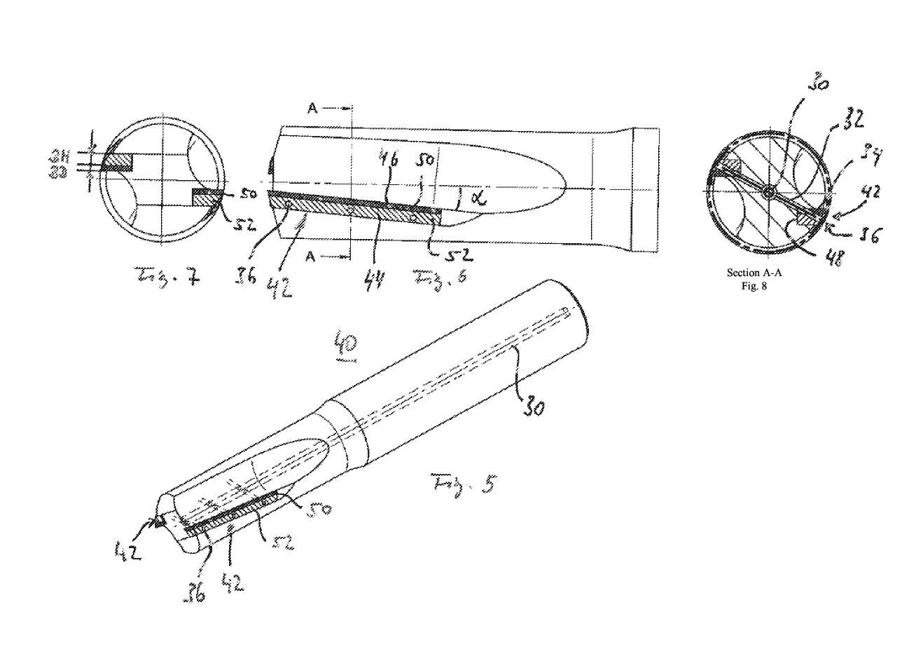

FIGS. 1 to 4 show a first embodiment of a cutting tool 10 in the form of a shaft miller. The shaft miller 10 comprises a tool body 12 with a front, shaft -shaped working section 18 on which two cutting inserts 14 are fastened with the same distribution on the circumference. The cutting inserts 14 consisting, e.g., of solid PCD have substantially the shape of rod-shaped circular segments with a width BS of preferably BS=2.5 mm that extend in the longitudinal direction of the tool body 12 relative to a central axis 16 with a spiraling angle α.

The cutting inserts 14 each comprise a cutting edge 18—a so-called jacket cutting edge—extending radially out of the tool body 12 and comprise a cutting edge 20—a so-called front cutting edge—projecting axially to the front over the tool body 12.

Free surfaces 22, 24 with different free angles are adjacent to the cutting edge 18 in the circumferential direction. The cutting inserts 14 are soldered into fitting longitudinal slots milled into the tool body that extend along the spiraling angle α.

The cutting inserts 14 form chip surfaces 26, wherein the latter run parallel or substantially parallel to a radial plane 26 in the cutting plane. A chip space 28 produced by a milling out in the circumferential surface of the tool body 12 is present in front of each chip surface 26 in the direction of rotation of the friction tool. The chip space 28 is shaped in a circular arc in cross section and also extends along the spiraling angle α.

The cutting tool is characterized in that a central coolant conduit 30 is connected via several shunt conduits 32 running in the tool body to radially running coolant conduit sections 34 that run completely as a borehole through the cutting inserts 14 and empty in a mouth opening 36 in the free surface 24.

Coolant is supplied under a high pressure of more than 40 bar through the central coolant conduit 30, the shunt conduits 32 and the coolant conduit sections 34 in the cutting inserts 14 and cools the cutting inserts 14 from the inside toward the outside.

In order to achieve a further improvement of the cooling and to produce a coolant film 38 on a workpiece surface to be worked along the longitudinal extension of the cutting insert 14, it is provided that a plurality of mouth openings 36 are provided along the longitudinal extension of the cutting insert 14 in the free surface 24.

Consequently, not only the cooling of the cutting inserts 14 but also the lubrication of a workpiece surface to be worked on is improved by the embodiment according to the invention. Furthermore, an improved removal of chips from the chip space 28 is also achieved by washing the latter by the coolant exiting from the free surface of the advancing cutting insert.

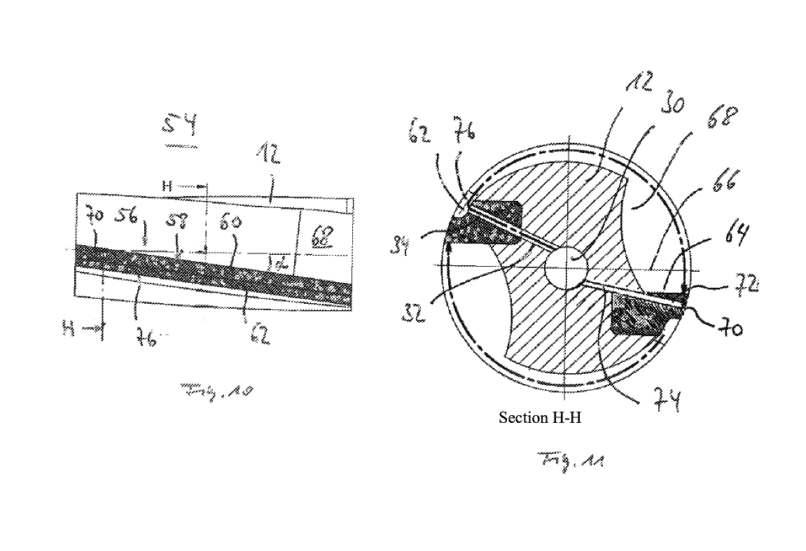

FIGS. 5 to 8 show a second embodiment of a cutting tool 40 in the form of a shaft miller. The shaft miller 40 differs from the embodiment of the shaft miller according to the FIGS. 1 to 4 in that the latter comprises cutting inserts 42 constructed as a sandwich PCD or a sandwich CBN. The cutting inserts 42 comprise a hard metal carrier 44 with a width BH of preferably BH=1.5 mm on which a PCD or CBN diamond layer 46 with a width BD of preferably BD=1 mm is arranged. The cutting inserts 42 are received in grooves milled in along the spiraling angle a and fastened to them such as by soldering.

On the circumferential side the diamond component 46 forms a first free surface 50 and the hard metal section 44 forms a second free surface 52. The coolant conduit sections 34 are introduced in the radial direction such as by drilling into the second free surface 52 under the formation of mouth openings 36. A plurality, in the present embodiment three mouth openings 36 with associated coolant conduit sections 34 are provided along the longitudinal extension of the cutting insert 42.

FIGS. 9 to 14 show a third embodiment of a cutting tool 54 in the form of a friction tool. The friction tool 54 has a construction corresponding to the construction of the cutting tool according to FIGS. 1 to 4, wherein the cutting inserts 56 are constructed from solid PCD or solid CBN and have a cutting edge 58 extending radially out of the tool body 12, which cutting edge is followed in the circumferential direction by a round, beveled surface 60 and by a free surface 62.

The cutting insert 56 forms a chip surface 64, wherein the latter runs parallel or substantially parallel to a radial plane 66 in a cutting plane. A chip space 68 produced by a milling out in the circumferential surface of the tool body 12 is present in front of each chip surface 64 in the direction of rotation of the friction tool. The chip space 68 is shaped in a circular arc in cross section and also extends along the spiraling angle a.

The friction tool 54 is characterized over the prior art in that at least one mouth opening 70 for coolant is provided on the circumferential side in the round, beveled surface 60 which opening empties via a coolant conduit section 72 running completely through the cutting insert 56 via a shunt conduit 74 into the central coolant conduit 30. Moreover, mouth openings 76 are provided in the free surface 62 which are connected via the coolant conduit sections 34 and the shunt conduits 32 to the central coolant conduit 30. In the embodiment shown the mouth opening 70 of the round, beveled surface 60 is constructed to be elliptical in a top view and funnel-shaped in cross section.

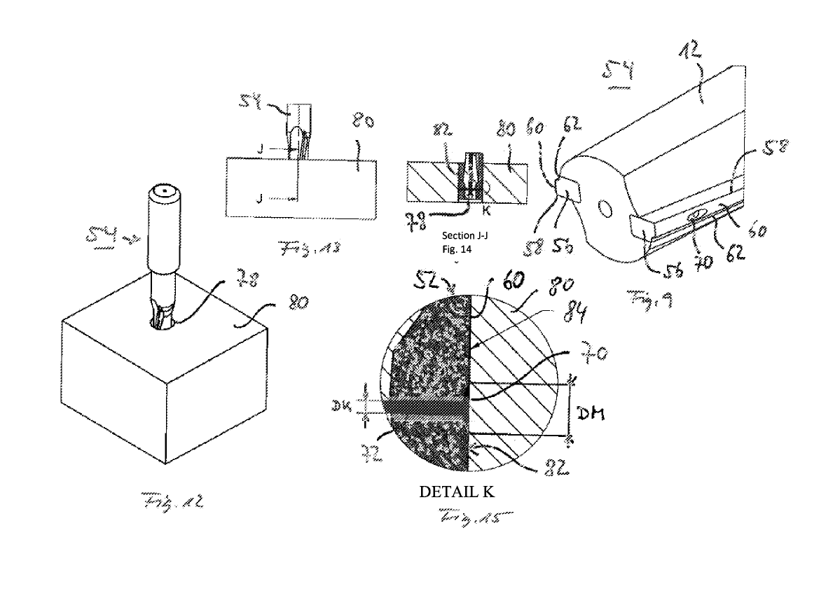

FIG. 12 shows a use of the friction tool 54 for the fine working of a borehole 78 in a workpiece 80. The surface quality as well as the accuracy of the shape and the dimensions of the borehole 78 should be improved by the so-called “friction”.

FIG. 14 shows a sectional view of the borehole 78 along the section line J-J according to FIG. 13, wherein the round, beveled surfaces 60 of the cutting inserts 52 rest on an inner wall 82 of the borehole 78.

FIG. 15 shows an enlarged cross-sectional view of the coolant conduit sections 72 with a diameter DK with a round or oval mouth opening 70. In order to achieve an effective distribution of the coolant for forming an oil film 84 between the round, beveled surface 60 and the inner wall 82 of the borehole 78, it is provided that the mouth opening 70 is constructed like a funnel. The mouth opening 70 can preferably be constructed as a depression with a diameter DM.

As a deviation from the friction tool shown in the drawings, the inventive concept can also be used with other cutting tools with cutting inserts consisting of SOLID PCD or SOLID CBN, sandwich PCD, sandwich CBN and/or hard metal, e.g. in the case of milling tools or drilling tools, wherein another cutting geometry, other chip angle and/or other shape of the surface, round, bevel surface and/or free surface are used.

When using solid PCD material or solid CBN or sandwich material, at first the longitudinal slots are built into the tool body 12 into which the cutting inserts 24, 42, 56 are then inserted as rod-shaped circular segments and welded. Then, the coolant conduit sections and mouth openings are introduced into the PCD material or CBN material or hard material in a sandwich construction also by an electrical erosion method. The spiraling cutting edges, the chip surfaces, the round, beveled surfaces and/or the free surfaces are subsequently eroded by an eroding machine. A laser method can also be used as an alternative to an electrical erosion method.

1. A cutting tool (10, 40, 54), especially a friction tool, milling tool or drilling tool, with at least one cutting insert (14, 42, 56) fastened on a tool body (12) and comprising at least one free surface or at least one round, beveled surface and preferably comprising at least one free surface, preferably consisting of polycrystalline diamond (PCD) or cubic boron nitride (CBN), wherein a coolant conduit (30) run through the tool body (12) forms a connection to at least one coolant conduit section (32, 34, 72) worked into the cutting insert (14, 42, 56) and with at least one mouth opening (36, 70, 76) in the round, beveled surface (60) and/or free surface (24, 44, 62) of the cutting insert (14, 42, 56).

2. The cutting tool according to claim 1,
characterized in
that the coolant conduit section (32, 34, 72) runs completely in the cutting insert (24, 42, 56).

3. The cutting tool according to claim 1,
characterized in
that the mouth opening (70) worked into the round, beveled surface (60) is funnel-shaped.

4. The cutting tool according to claim 1,
characterized in
that the coolant conduit section (32, 34, 72) is constructed as a borehole through the cutting insert (14, 42, 56).

5. The cutting tool according to claim 1,
characterized in
that the cutting insert (14, 56) is constructed as a solid PCD or solid CBN with a width BS in the range of 1.5 mm≦BS≦5 mm, preferably BS=2.5 mm.

6. The cutting tool according to claim 1,
characterized in
that the cutting insert (42) is constructed as a sandwich PCD or sandwich CBN with a hard metal carrier with a width BH in the range of 1 mm≦BH≦2 mm, preferably BH=1.5 mm, and a PCD- or CBN layer with a width BD in the range of 0.5 mm≦BD≦1.5 mm, preferably BD=1 mm.

7. The cutting tool according to claim 2,
characterized in
that the coolant conduit section (32) has a diameter of DK in the range of 0.15 mm≦DK≦1.5 mm, preferably DK=0.6 to 0.8 mm.

8. The cutting tool according to claim 3,
characterized in
that the funnel-shaped mouth opening (76) has a diameter DM in the range of 0.5 mm≦DM≦1.5 mm, preferably DM=1 mm.

9. The cutting tool according to claim 1,
characterized in
that the cutting tool (10, 40, 54) is a drilling tool, milling tool or friction tool.

10. The cutting tool according to claim 1,
characterized in
that the cutting insert (14, 42, 56) comprises several mouth openings (36, 70, 76) for coolant along the longitudinal direction of the round, beveled surface (60) and/or free surface (24, 44, 62).

11. The cutting tool according to claim 1,
characterized in
that the coolant conduit sections (32) have a radial course.
